(19) United States
(12) Patent Application Publication
(10) Pub. No.: US 2018/0157624 A1
(43) Pub. Date: Jun. 7, 2018

(54) ELECTRONIC FORM SYSTEM AND METHOD FOR EDITTING FORM THEREOF

(71) Applicant: Hundred Plus Corporation Ltd., TAIPEI CITY (TW)

(72) Inventors: Edwin Kwok Lun Ng, Taipei (TW); Chung Jen Lin, Taipei (TW)

(21) Appl. No.: 15/371,221

(22) Filed: Dec. 7, 2016

(51) Int. Cl. G06F 17/21; G06F 17/22; G06F 17/24

(52) U.S. Cl. CPC G06F 17/211; G06F 17/243; G06F 17/2264

(57) ABSTRACT

Disclosed is an electronic form system capable for transforming directly a form format of the existing document processing software to a form editor of the electronic form system. A copy instruction of the existing document processing software is used to copy the form format by the form editor. Further, a pasting instruction of the form editor is used, so that the form format is directly pasted into the form editor. Therefore, the form format into the form editor is directly edited by the user to form a necessary electronic processing form.

### (a) TECHNICAL FIELD OF THE INVENTION

The present invention relates to an electronic form system and a method for editing form thereof, and more particularly to a method for editing a form capable of editing on an electronic form system.

### (b) DESCRIPTION OF THE PRIOR ART

The mobile internet and the broadband network have been very popular and stable nowadays. In order to shorten the time of the approval process and prevent the limitations in time and space resulting in missing the best opportunity of the approval in the private enterprise or the government departments, an online approval system is introduced in many private enterprises. The forms may be filled out and approved and reviewed on time by the online approval system, the online approval system not only prevent the shortcomings of a long time of approval and review, but also reduce the usage amount of paper to achieve a paperless working environment.

The plurality of software for online approval has been developed in the market; however, the functions of “intuitiveness of operation and usage” on the form editor is not considered and is short of the “interoperability” between the document processing software and the well-known online approval system. For example, it cannot make sure that the introduced form format may accept or not in the well-known electronic form editor; therefore, it should be repeatedly amended or tested.

On the other hand, the big business commonly has sufficient resources to establish the task force, and the education and training of using the electronic form tools is performed by a professional information technology staff to known well the usage of “electronic form design tools”. However, the small and medium enterprises burden too heavily with the manpower and time of knowing well electronic form design tools.

Therefore, if the interoperability between the electronic approval and review system and the existing document processing system is enhanced, and intuitiveness and convenience of the operation and usage are enhanced, so that the form is more simply and easily formed to reduce difficulties of electronic approval in the enterprises.

### SUMMARY OF THE INVENTION

An object of the present invention is to provide a method for editing an electronic form system. A form format of the existing document processing software may be directly transformed to a form editor of the electronic form system by the electronic form system, and an electronic processing form is formed by the form editor.

To achieve above object, a copy instruction of the existing document processing software is directly used to copy the form format by a user, and a pasting instruction of the form editor is used, so that the form format is directly pasted on the form editor. Therefore, the form format into the form editor may be directly edited to form finally the necessary electronic processing form.

Therefore, the user does not need to learn the complicated programming language, and the user only needs to have the knowledges and habits for using the document processing software, so that the form format of the existing document processing software may be directly and easily transformed to the electronic form system of the present invention to perform the following steps. On the other hand, the necessary electronic processing form may be quickly formed by a visual editing method.

Another object of the present invention is to provide an electronic form system. The necessary electronic processing form may be easily formed by a person who edits the form, and the electronic processing form may be simultaneously filled out and approved on the computer device and the mobile device by the user to achieve an electronic approval and paperless work environment.

To achieve above object, the electronic form system includes a form editor, a form format database and a form content database; wherein a form format of the existing document processing software is directly transformed into the form editor to form an electronic processing form. The completed electronic processing form may be stored into the form format database. The form content database is used for integrating and counting data; wherein the electronic processing form after filling out may be transmitted into the form content database to perform a data processing step. The electronic processing form is read from the form content database to perform an approval and review when the electronic processing form after filling out is to be approved and reviewed.

These and other objectives of the present invention will undoubtedly become obvious to those of ordinary skill in the art after reading the following detailed description of the preferred embodiment that is illustrated in the various figures and drawings.

### BRIEF DESCRIPTION OF THE DRAWINGS

FIG. 1 is a system architecture diagram of an electronic form system and a form editor including thereof of the present invention.

FIG. 2 is a schematic view of an existing document processing software having a form format of the present invention.

FIG. 3 is a schematic view of a form format of the existing document processing software pasted to the form editor of the present invention.

FIG. 4 is a schematic view of editing the existing form format by the form editor to form an electronic processing form.

FIG. 5 is a schematic view of writing the electronic processing form.

FIG. 6 is a flowchart according to a first embodiment of the present invention.

FIG. 7 is a flowchart according to a second embodiment of the present invention.

FIG. 8 is a flowchart of filling out and approving the electronic processing form according to the present invention.

FIG. 9 illustrates the electronic processing form to be filled out on a browser of a computer device by an applicant according to the second embodiment of the present invention.

FIG. 10 illustrates the electronic processing form to be filled out on a browser of a mobile device by an applicant according to the second embodiment of the present invention.

### DETAILED DESCRIPTION OF THE PREFERRED EMBODIMENTS

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

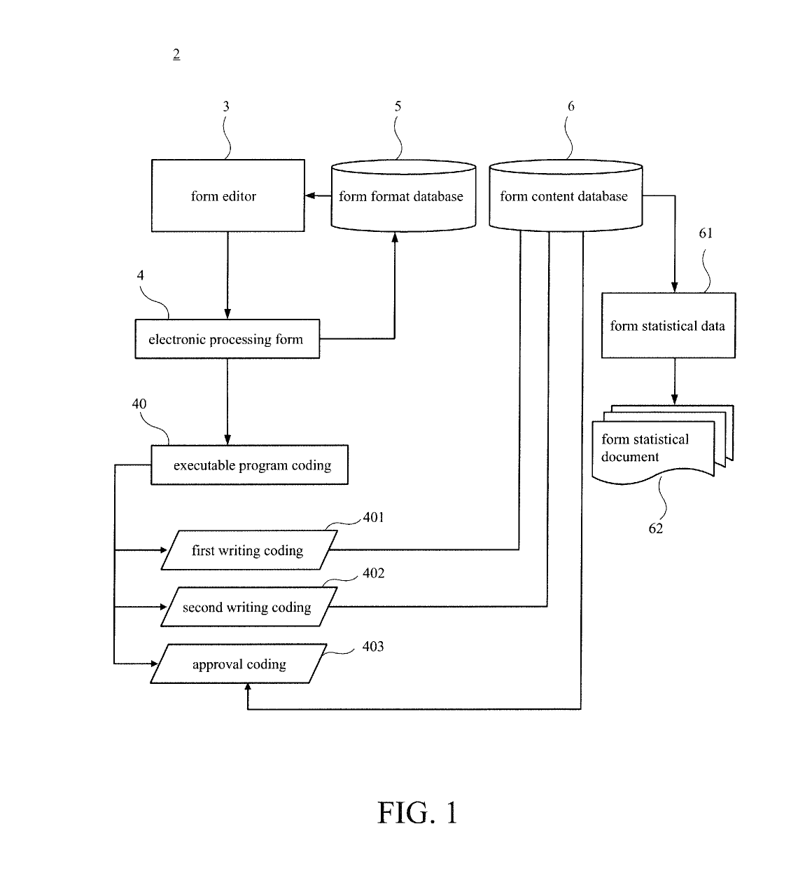

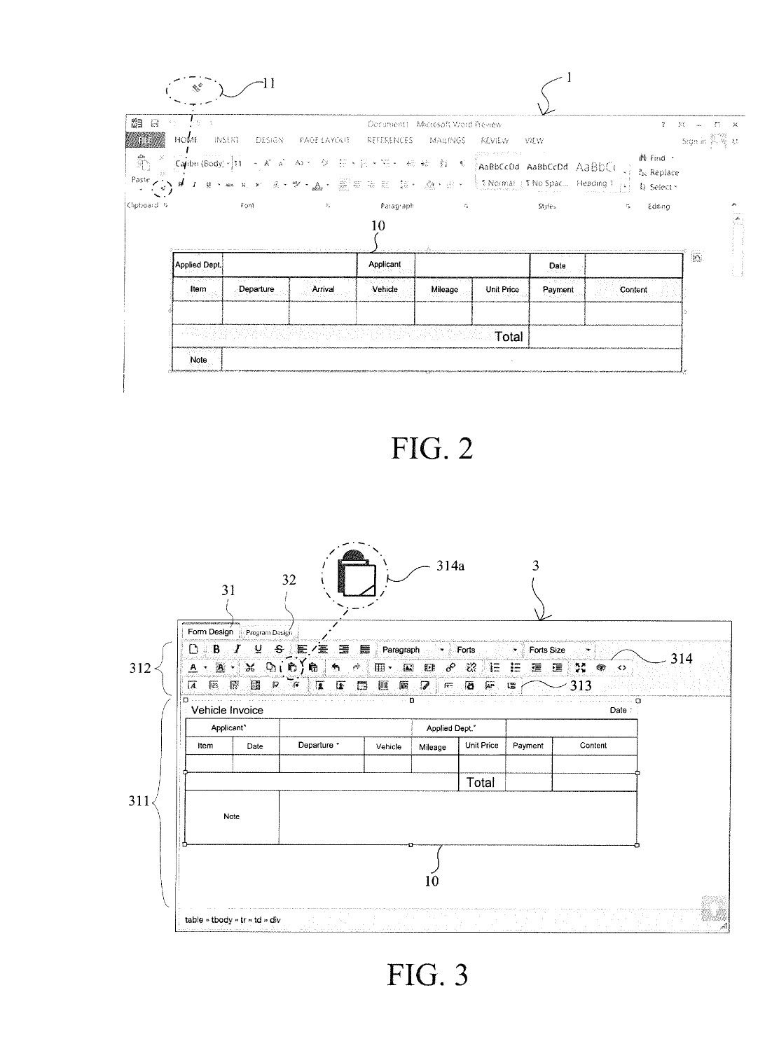

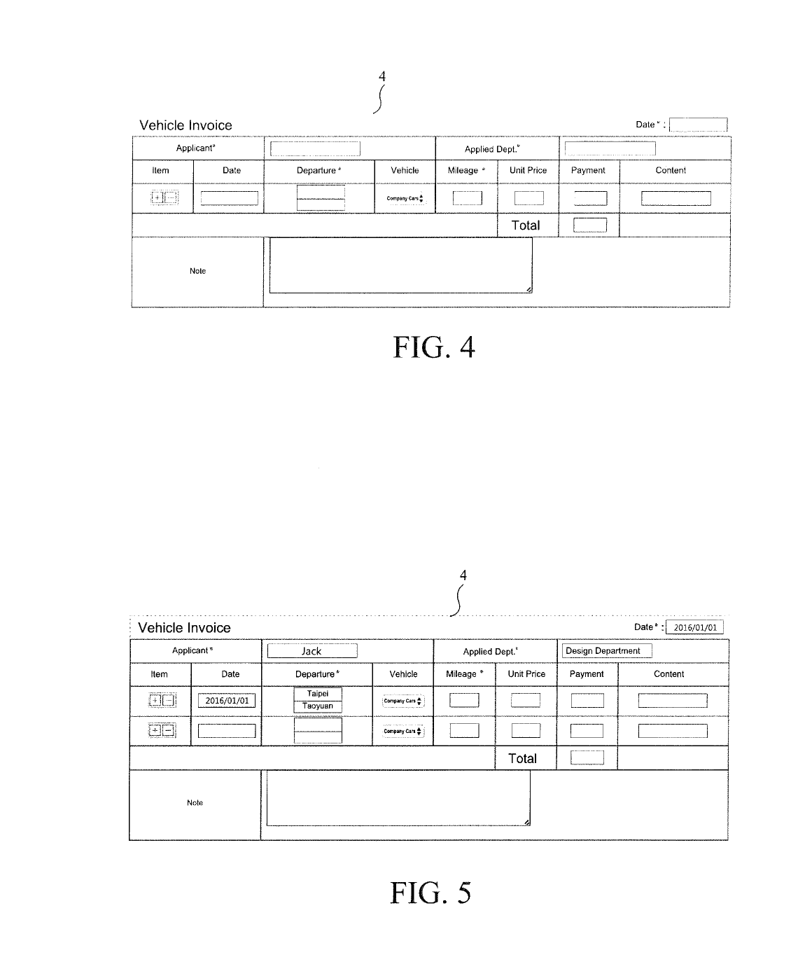

Please refer to FIG. 1, a basic framework of an electronic form system of the present invention is disclosed. The electronic form system 2 includes a form editor 3, a form format database 5 and a form content database 6; wherein a form format 10 of an existing document processing software 1 (as shown in FIG. 2) may be transformed into a form editor 3 of the present invention (as shown in FIG. 3), and an electronic processing form 4 is formed by the form editor 3 (as shown in FIG. 4). The electronic processing form 4 after editing may be stored into the form format database 5 to establish a template of the electronic processing form.

A form content database 6 is used for fill out form data storing, integrating and counting; wherein the electronic processing form 4 after filling out may be transmitted to the form content database 6 to perform a data processing step. Further, the electronic processing form 4 may be read from the form content database 6 to perform an approval and review when the electronic processing form 4 after filling out is to be approved and review. The form content database 6 is performed a form statistical data processing 61, and the form content database 6 is exported the statistical data to a form statistical document 62.

Furthermore, the technical features of the form editor 3 are described in detail, and please refer to FIG. 2, FIG. 3 and FIG. 4. As shown in FIG. 3, the form editor includes a first design district 31 displayed a visual form format and a second design district 32 edited by a programming language.

The first design district 31 has a first district 311 and a second district 312. The existing form format 10 as shown in FIG. 2 is pasted into the first district 311. The existing form format 10 may be directly transformed to the form editor 3 of the electronic form system 2 of the present invention to edit the electronic processing form by a person who can operate the common document software but cannot understand programming language. Additional, an error of the unnecessary format whether is formed or not may be confirmed in the transforming process. The second design district 32 includes the programming language edited by a professional; therefore, the second design district 32 is not explained in detail.

Please refer to FIG. 3, a pasting instruction 314a is disposed on a second district 312, and a principle of the pasting instruction 314a is the same as the existing document processing software; therefore, the pasting instruction 314a may be learned and operated easily by a user. In detail, the second district 312 further includes a plurality of form design components 313 and a plurality of edit instructions 314 other than the pasting instruction 314a to edit the necessary electronic processing form. For example, the form design component 311 may include a text form design, a number form design, a user form design, a bar code form design, a data form design, a picture form design, a signature form design and so on, and the necessary system forms may be embedded in the existing form format 10. Further, the edit instruction 314 may include the edit instructions of the common document software, such as copy, paste, paragraph, type size, and so on.

It should be noted that the form design component 313 and the edit instruction 314 in the second district 312 may be randomly varied based on actual requirements or the development of program, but the present invention is not limited to the aforementioned description and figures.

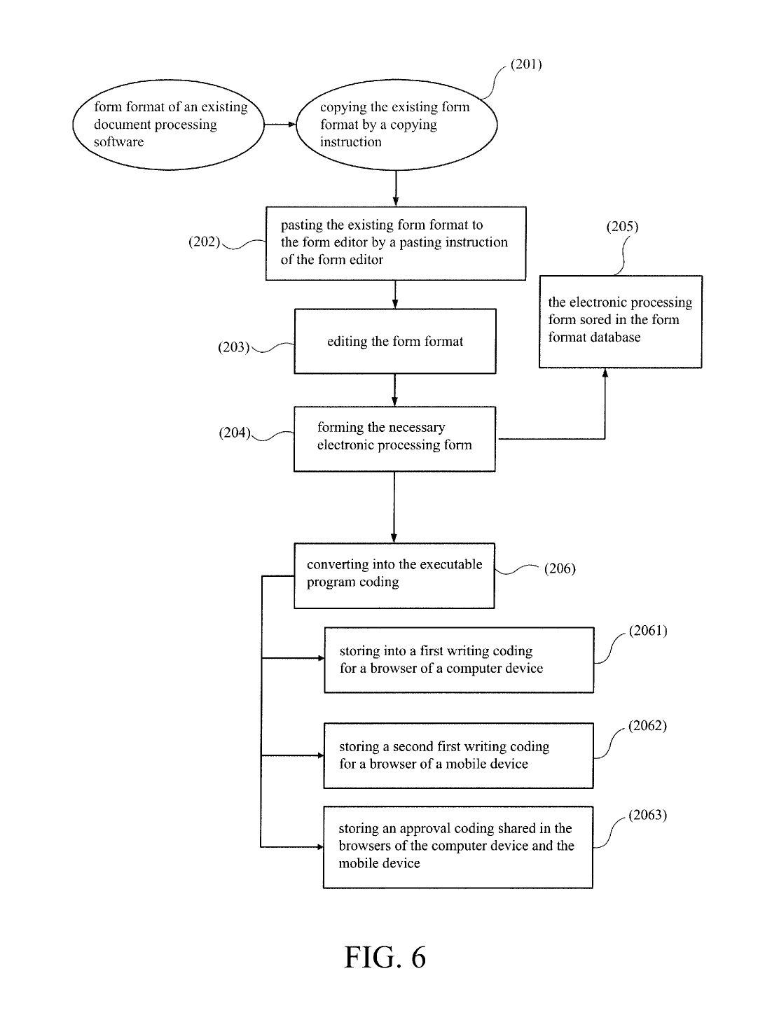

The technical features of the electronic processing form 4 will be described as below, and please refer to FIG. 1 and FIG. 6. First, please refer to FIG. 1, in order to apply the electronic processing form 4 to the browsers of the computer device and the mobile device to fill out and approve the electronic processing form 4; therefore, the electronic processing form 4 is converted to an executable program code 40, and is stored into the electronic form system in the formats of a first form fill out code 401, a second form fill out code 402 and an form approval and review code 403. Furthermore, as shown in FIG. 6, the electronic processing form 4 is displayed on the browser of a computer device by the first form fill out code 401 for filling out the form. The electronic processing form 4 is displayed on the browser of a mobile device 8 by the second form fill out code 402 for filling out the forms. The electronic processing form 4 is displayed on the browsers of the computer device 7 and the mobile device 8 by the form approval and review code 403 for approving and reviewing the forms.

In detail, the program files, such as PHP or HTML, may be used in the executable program code 40, the first form fill out code 401, the second form fill out code 402 and the form approval and review code 403. Additionally, the program files written by other program languages may be used, as long as the electronic processing form may be applied and displayed to the browsers of the computer device and the mobile device. The existing document processing software may be the MS Word software for a charge or the Open Office Writer software for free, and the iOS or Android system may be used in the mobile device.

According to the aforementioned technical features, because the electronic form system 2 of the present invention is to provide an editing method of the form format, the user does not need to learn the complicated program language, and the form formats of the existing document processing software may be easily transformed to the form editor 3 of the present invention to perform the following steps. Further, the operating method and habits of the form editor 3 is similar as the existing document processing software; therefore, the user who uses the common document software may easily learn and operate the electronic form system 2 of the present invention to form a suitable electronic processing form.

The electronic form system and the editing and usage of the form editor thereof of the present invention will be described in detail from the following embodiment taken in conjunction with the accompanying drawings.

Please refer to FIG. 6, a usage flowchart of a first embodiment of the electronic form system 2 is disclosed. In the first embodiment, please refer to FIG. 2, the form format is preliminarily formed by the user in the existing document processing software 1. Furthermore, a copying instruction 11 of the existing document processing software may be directly selected to copy the existing form format 10 (step 201). Please refer to FIG. 3, the steps continuing the electronic form system 2 include: selecting a pasting instruction 314a of the form editor 3 to paste directly the existing form format 10 to the form editor 3 (step 202); so that the existing form format 10 of the form editor 3 may be directly edited (step 203) to form the necessary electronic processing form 4 (step 204).

In detail, the form designs which need to fill out are embedded in the existing form format 10 in the step 203 mainly. Alternatively, the word size, type size and form size make fine adjustments; however, the format of the existing form format 10 is not seriously influenced.

In order to transmit the electronic processing form 4 to the browsers of the computer device 7 and the mobile device 8 through a server to display and use the electronic processing form 4, the electronic processing form 4 (as shown in FIG. 5) which has been filled out may be converted into an executable program code 40 (step 206). Further, the executable program code is respectively stored into a first form fill out code 401 (step 2061), a second form fill out code 402 (step 2062) and a form approval and review code 403 (step 2063) to the server of the electronic form system.

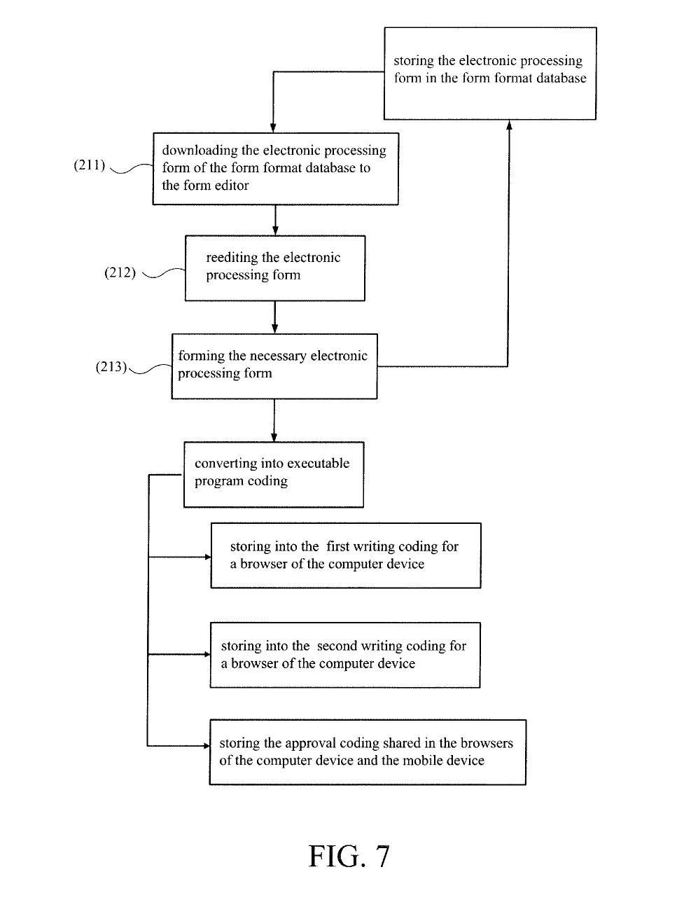

A person having ordinary skill in the art may understand that the form format database 5 is used for establishing a template of the electronic processing form format; therefore, the step of pasting the form format of the existing document processing software is omitted by the user and is instead of the other steps. As shown in FIG. 7, a flowchart of using the electronic form system of the second embodiment is disclosed.

In detail, the electronic processing form 4 of the form format database 5 is directly downloaded to the form editor 3 (step 211) by the user who edits the form, so that the electronic processing form may be edited again (step 212) to form the necessary electronic processing form (step 213). The step of converting the executable program code 40 of the second embodiment is the same as the first embodiment; therefore, the detailed contents does not describe any more.

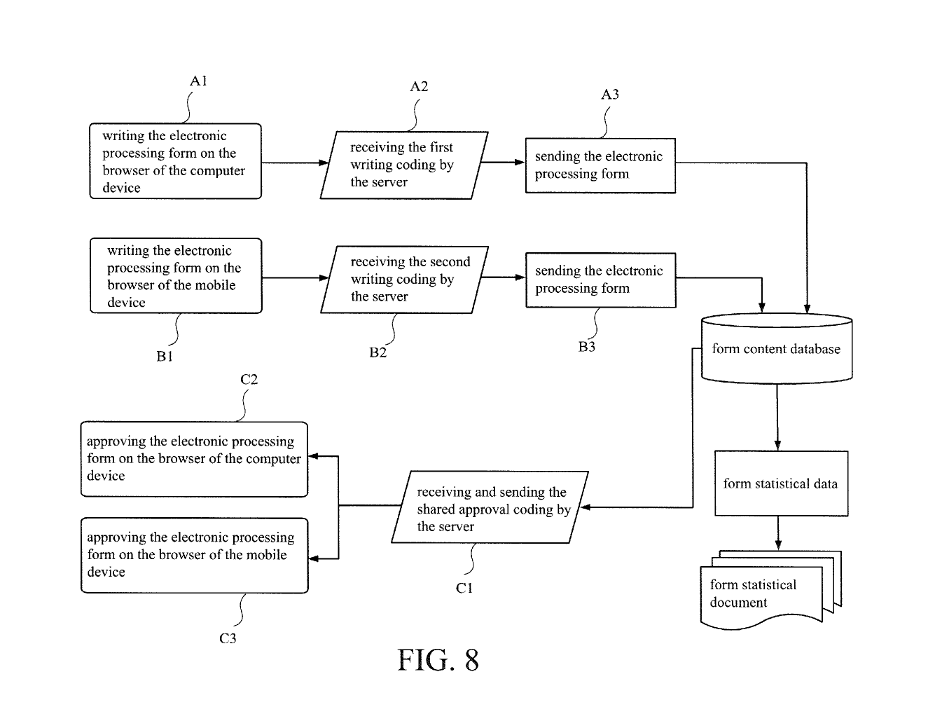

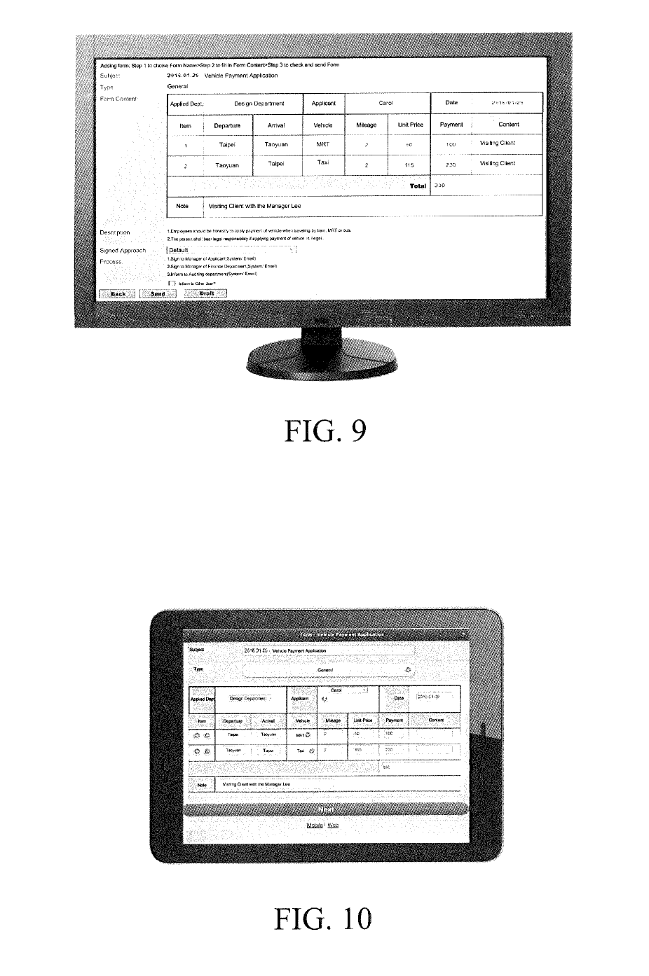

Finally, the electronic processing form 4 is how to apply to the browsers of the computer device 7 and the mobile device 8 to perform a writing step and an approval step, which will be explained in FIG. 8, FIG. 9 and FIG. 10. First, please refer to FIG. 5, the electronic processing form 4 may be filled out and added on the computer device 7 and the mobile device 8 by the user who edits the form.

Regarding to the form applied on the computer device 7 by an applicant, as shown in FIG. 9, after the electronic processing form 4 is filled out in the browser of the computer device 7 (step A1), the signal of first form fill out code 401 is received by the server (step A2), so that the electronic processing form 4 is transmitted back to the form content database 6 (step A3) to perform a data processing step.

Regarding to the form applied on the mobile device by the applicant, as shown in FIG. 10, after the electronic processing form 4 is filled out in the browser of the mobile device (step B1), the signal of the second form fill out code 402 is received by the server (step B2), so that the electronic processing form 4 is transmitted to the form content database 6 (step B3) to perform the data processing step.

When the examiner want to approve and review the aforementioned electronic processing form 4 after filling out, the electronic processing form 4 stored in the form content database 6 is transmitted by the form approval and review code 403, and the form approval and review code 403 shared in computer device and the mobile device is received by the server to transmit to the browsers of the computer device 7 and the mobile device 8 (step C1). Further, the electronic processing forms 4 may be approved and reviewed on the browsers of the computer device 7 and the mobile device by the reviewer respectively (step C2 and step C3).

To sum up, an editing method of the form format is provided in the form editor of the present invention; therefore, the present invention has a higher interoperability with the existing document processing system to enhance the intuitiveness of operation and usage. Therefore, the time of learning and operating the form editor are shortened, so that the necessary processing form is formed more effectively. Additionally, the electronic processing form is filled out and approved on the computer device and the mobile device simultaneously; therefore, the present invention really achieves the electronic approval and paperless work environment.

Those skilled in the art will readily observe that numerous modifications and alterations of the device and method may be made while retaining the teachings of the invention. Accordingly, the above disclosure should be construed as limited only by the metes and bounds of the appended claims.

I claim:

1. A method for editing an electronic form of an electronic form system, comprising a form editor capable of transforming directly a form format of an existing document processing software to the electronic form system, and an electronic processing form formed by the form editor; wherein the method comprises steps as follows:
copying the form format by using a copying instruction of the existing document processing software;
pasting directly the form format to the form editor by using a pasting instruction of the form editor;
editing directly the form format in the form editor; and
forming directly the necessary electronic processing form.

2. The method for editing an electronic form of an electronic form system of claim 1, wherein the form editor comprises a first design district and a second design district.

3. The method for editing an electronic form of an electronic form system of claim 2, wherein the form format is directly pasted into a first district of the first design district.

4. The method for editing an electronic form of an electronic form system of claim 1, further comprising a step of storing the completed electronic processing form into a form format database.

5. The method for editing an electronic form of an electronic form system of claim 1, further comprising a step of converting the electronic processing form to an executable program code.

6. The method for editing an electronic form of an electronic form system of claim 5, further comprising a step of storing respectively the executable program code into a first form fill out code, a second form fill out code and an approval code; wherein the first form fill out code is capable of displaying the electronic processing form on a browser of a computer device and is used for filling form the form; the second form fill out code is capable of displaying the electronic form on a browser of a mobile device and is used for filling out the form; and the form approval and review code is capable of sharing the electronic form to the browsers of the computer device and a mobile device and is used for approving and reviewing the form.

7. The method for editing an electronic form of an electronic form system of claim 6, wherein the electronic form system has a form content database for fill out form data storing, integrating and counting, and the method comprises the following steps:
transmitting the electronic processing form to the form content database by the first form fill out code after filling out the electronic processing form into the browser of the computer device;
transmitting the electronic processing form back to the form content database by the second form fill out code after filling out the electronic processing form into the browser of the computer device;
and reading the electronic processing form after filling out from the form content database when the written electronic processing form is to be approved and reviewed, so that the form approval and review code is transformed to the browsers of the computer device and the mobile device to perform an approval and review.

8. The method for editing an electronic form of an electronic form system of claim 1, wherein the existing document processing software is MS Word or Open Office Writer.

9. An electronic form system, comprising:
a form editor capable of transforming a form format of an existing document processing software into the form editor to form an electronic processing form;
a form format database capable of storing the completed electronic processing form into the form format database; and
a form content database for fill out form data storing, integrating and counting;
wherein the electronic processing form after filling out is transmitted to the form content database to perform a data processing step; and
the electronic processing form is read from the form content database to perform an approval and review when the electronic processing form after filling out is to be approved and reviewed.
